(19) United States
(12) Patent Application Publication
(10) Pub. No.: US 2004/0208723 A1
(43) Pub. Date: Oct. 21, 2004

(54) Anti-tamper device having an inner shell and an outer shell that rotate independently

(76) Inventor: Rafal Stawarski, Schaumburg, IL (US)

Correspondence Address: WILDMAN, HARROLD, ALLEN & DIXON, 225 WEST WACKER DRIVE, CHICAGO, IL, 60606, US

(21) Appl. No.: 10/413,641

(22) Filed: Apr. 15, 2003

(51) Int. Cl. F16B 21/00

(52) U.S. Cl. 411/349

(57) ABSTRACT

A anti-tamper device with an inner shell having a body and an end. An outer shell is positioned to cover the end of the inner shell. The inner shell and the outer shell are axially and rotatably secured together such that the inner shell and the outer shell rotate independent of each other. A method of making the anti-tamper device includes selecting the inner shell, selecting the outer shell, and securing the inner shell to the outer shell such that the inner shell and the outer shell rotate independent of each other. An anti-tamper kit is provided an anti-tamper device and a key.

### BACKGROUND

Thieves have stolen hub caps and tires for as long as the automobile has existed. Stealing a hub cup or tire requires the thief to first remove, typically with a wrench, the lug nuts that connect the tire or hub cap to the wheel of an automobile. Thus far, prevention has centered on providing unique lug nuts, having unique shapes or configurations, that can only be removed by using a corresponding unique wrench, which only the owner has access to. Unfortunately, unique lug nuts provide a false sense of security because a number of tools and wrenches exist, often for legitimate purposes, that can grip the outside surface of a unique lug nut and often allow the application of torque thereto. Therefore, what is needed is an anti-tamper device that prevents the application of torque to a lug nut.

### SUMMARY

The shortcomings of the existing art are overcome and additional advantages are provided through the provision of an anti-tamper device having an inner shell and an outer shell that rotate independent of each other.

In one example, the anti-tamper device comprises an inner shell having a body and an end. An outer shell is positioned to cover the end of the inner shell. The inner shell and the outer shell are axially and rotatably secured together such that the inner shell and the outer shell rotate independent of each other.

In another example, a method of making the anti-tamper device is provided. The inner shell is selected. The outer shell is selected, and the inner shell is secured to the outer shell such that the inner shell and the outer shell rotate independent of each other.

In a further example, an anti-tamper kit is provided. The kit includes an anti-tamper device having an inner shell with a body and an end. An outer shell is positioned to cover the end. The inner shell and outer shell are axially and rotatably secured together such that the inner shell and the outer shell rotate independent of each other. The kit also includes a key for engaging the anti-tamper device to apply torque thereto.

### BRIEF DESCRIPTION OF THE DRAWINGS

FIG. 1 is an exploded view of one example of an anti-tamper device including an inner shell and an outer shell.

FIG. 2 is a side perspective view of the anti-tamper device of FIG. 1 shown with a corresponding key that is engageable with the anti-tamper device.

FIG. 3 is an exploded view of another example of an anti-tamper device including an inner shell and an outer shell.

FIG. 4 is a side perspective view of the anti-tamper device of FIG. 3 shown with a corresponding key that is engageable with the anti-tamper device.

### DETAILED DESCRIPTION

It should be appreciated that many variations can be made to the following detailed description without departing from the scope of the invention as set forth herein.

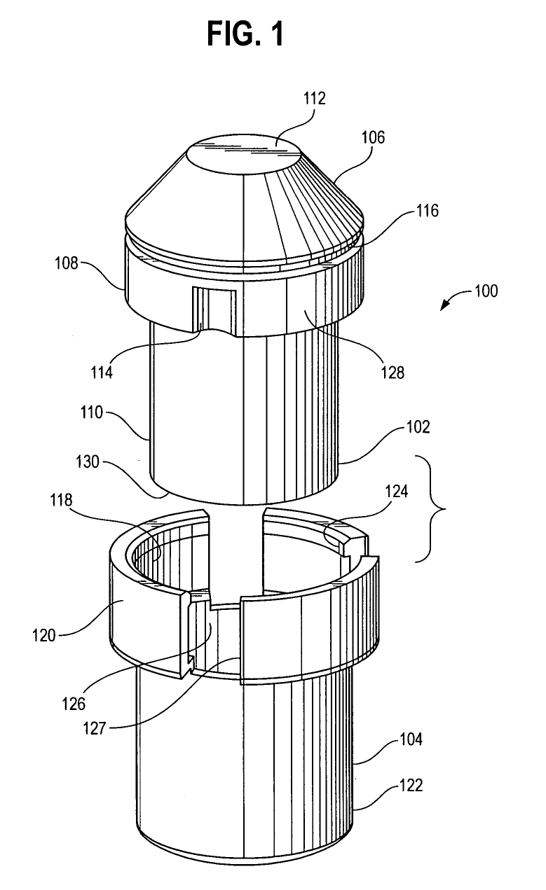

Referring to FIG. 1, anti-tamper device 100 in one example comprises inner shell 102 and outer shell 104. Inner shell 102 and outer shell 104 can be made of a variety of materials. If anti-tamper device 100 were implemented as a lug nut, then a material would have to be chosen that is appropriate for lug nut. For example, inner shell 102 and outer shell could be made from AISI 86B30 or 4140 steel. If anti-tamper device 100 were implemented as another type of device, such as a standard nut, then an appropriate material would have to be chosen. It should be noted, however, that inner shell 102 and outer shell 104 could also be made of a combination of materials above. Similarly, inner shell 102 could be made of one material or combination and outer shell 104 could be made of another material or combination.

Inner shell 102 in one example comprises frustoconical portion 106, first cylindrical portion 108, and second cylindrical portion 110. Frustoconical portion 106 in one example includes a threaded or grooved opening 112 for threadingly receiving a bolt (not shown). First cylindrical portion 108 in one example has a greater radius than second cylindrical portion 110. First cylindrical portion 108 includes one or more engagement surfaces 114 positioned in a predetermined configuration or spacing around first cylindrical portion 108. In one example, engagement surfaces 114 are grooves carved into the outer wall of first cylindrical portion. A channel is included on first cylindrical portion 108. In one example channel 116 is positioned circumferentially about and extends 360 degrees around the sidewall of inner shell. Channel 116 is utilized to rotatably attach inner shell 102 and outer shell 104 together, as will be discussed herein.

Outer shell 104, in one example, forms an enclosure 118 that contains at least a portion of inner shell 102. Outer shell 102 comprises first cylindrical portion 120 and second cylindrical portion 122. In one example, first cylindrical portion 120 has a greater radius than second cylindrical portion 122. Ridge 124 is formed along a surface within enclosure 118. Ridge 124 engages and communicates with channel 116 of inner shell thereby rotatably and axially securing inner shell 102 and outer shell 104 together. Ridge 124 in one example is positioned circumferentially about and extends 360 degrees around enclosure 118.

Alternatively, ridge 124 could extend around only a portion of enclosure 118. Also, ridge 124 could comprise a single protrusion extending from the sidewall of outer shell 104 into enclosure 118. The possibilities are numerous provided that ridge 124 is sufficient to engage and communicate with channel 116 such that inner shell 102 and outer shell 104 are rotatably and axially connected together. In another example, channel 116 could be located within enclosure 118 of outer shell 104 and ridge 124 could be located on the external surface of inner shell 102. Inner shell 102 and outer shell 104 could also be rotatably and axially secured together through the use of other means, such as a screw or bolt positioned at the center of the ends of inner shell 102 and outer shell 104 respectively.

The applicant does not intend to limit the inner shell 102 or outer shell 104 to the shape or configurations shown. The disclosure envisions that inner shell 102 and outer shell 104 could comprise combinations of shapes and configurations. For example, inner shell 102 could be a cylinder having a constant radius polygonal. The same is true with respect to outer shell 104. Inner shell 102 could be a lug nut for an automobile or another type of nut (the disclosure is not limited to automobiles). Inner shell 102 can have any shape, as long as it is adapted to be rotatably and axially connected to outer shell 104. Outer shell 104 can have any shape as long as it is rotatably and axially connected to inner shell 102. The ultimate shape, configuration, and means of attachment of inner shell 102 and outer shell 104 will depend on the goals and objectives of the designer, manufacturer, seller, and/or user of anti-theft device 100.

Referring further to FIG. 1, one or more openings 126 are located on the wall 127 positioned along the directrix of first cylindrical portion 120 of outer shell 104. Openings 126 in one example are positioned in the same predetermined configuration or spacing as engagement surfaces 114 of inner shell 102. Openings 126 expose one or more portions of the exterior surface of first cylindrical portion 108 of inner shell 102. Because openings 126 have the predetermined configuration of engagement surfaces 114, openings 126 and engagement surfaces 114 are capable of registration with each other.

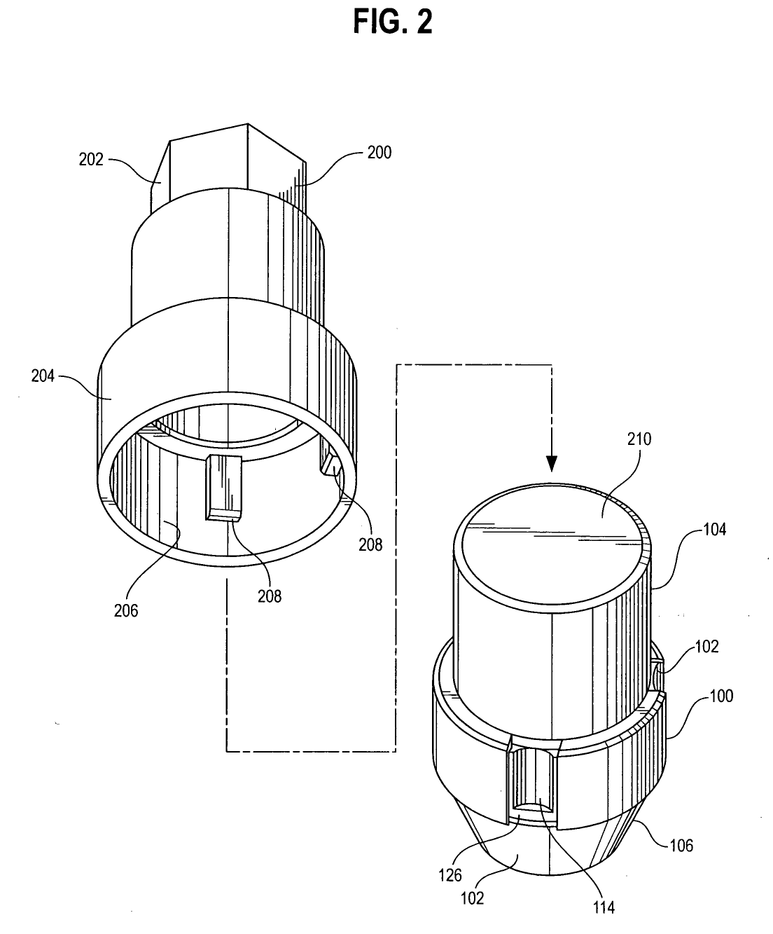

Referring to FIG. 2, key 200 is utilized to attach and remove anti-theft device from a bolt (not shown). Key 200 in one example comprises engagement portion 202 and socket portion 204. Engagement portion 202 in one example is used to attach key 200 to a socket wrench. Although it should be noted that engagement portion 202 could comprise a stand alone handle or any other means that would allow a user to grip key 200. Socket portion 204, in one example, includes an opening 206 for receiving at least a portion of anti-theft device 100. One or more protrusions 208 extend into opening 206 from an interior surface of socket portion 204. Protrusions 208, in one example, are positioned in the same spacing or predetermined configuration as engagement surfaces 114 of inner shell 102 and openings 126 of outer shell 104.

FIG. 2 also shows that end 210 of outer shell 104 is positioned to cover a corresponding end 130 (FIG. 1) of inner shell 102. Referring to FIGS. 1 and 2, a user attaches anti-tamper device 100 to a bolt by (in no particular order) rotating inner shell 102 and outer shell 104 such that engagement surfaces 114 are registered with openings 126 and inserting the bolt within opening 112. Socket portion 204 of key 200 is then fit over first cylindrical portion 120 and second cylindrical portion 122 of outer shell 104. If necessary, the user rotates key such that protrusions 208 extend through openings 126 and associate with engagement surfaces 114. The user can then apply torque to inner shell 102 either clockwise or counterclockwise so that inner shell will rotates on or off of the bolt. As can be seen, if a thief were to attempt to remove anti-tamper device 100 without the benefit of using key, outer shell 104 would simply rotate around inner shell 102 and the thief would not be able to apply torque to inner shell 102. Accordingly, the thief would not be able to remove anti-tamper device 100 from the bolt. Furthermore, since end 210 of outer shell 104 is positioned to cover a corresponding end 130 of inner shell 102, a thief will not be able to access inner shell 102 except through openings 126 because frustoconical portion 106 would be obscured and not readily accessible because of the recess in the hubcap within which anti-tamper device 100 fits. If anti-tamper device 100 were used for a non-automotive application, frustoconical portion 106 could be omitted, thereby allowing outer shell 104 to substantially cover inner shell 102.

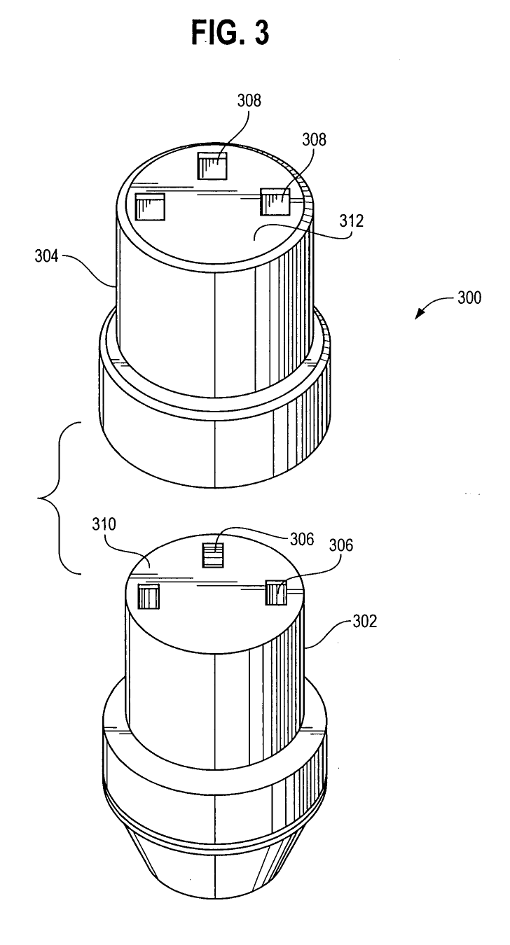

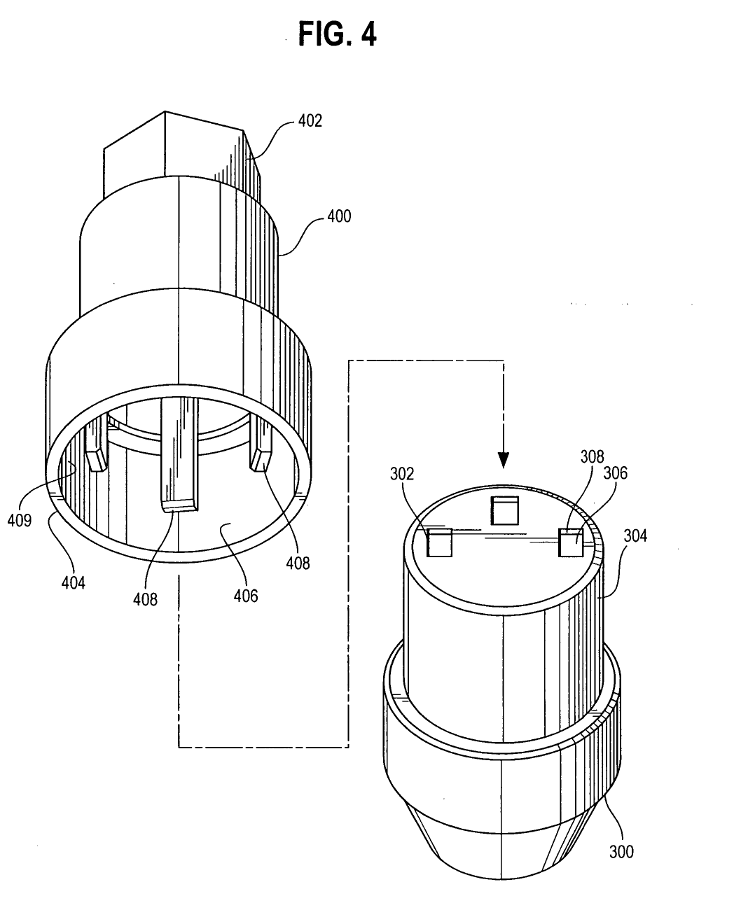

Referring to FIGS. 3 and 4, another exemplary anti-tamper device 300 is shown. Anti-tamper device 300 is similar to that shown in FIGS. 1 and 2 and comprises an inner shell 302 and an outer shell 304 that rotate independent of each other. In addition, end 312 of outer shell 304 is positioned to cover end 310 of inner shell 302. Also, inner shell 302 and outer shell 304 are rotatably and axially secured together. The difference is that engagement surfaces 306 and openings 308 are positioned on the respective bases or ends 310, 312 of the inner shell 302 and outer shell 304 respectively. Engagement surfaces 306 in the example are depressions or holes in end 310 of inner shell 302. Key 400 is similar to key 200 shown in FIG. 2 and comprises an engagement portion 402 and a socket portion 404. Socket portion 404 defines an opening 406 containing protrusions 408 that are not connected to the sidewall 409 of socket portion 404. To apply or remove anti-tamper device to a bolt, a user must rotate inner shell 302 and outer shell 304 so that engagement surfaces 306 and openings 308 are in registration with each other. Anti-tamper device 300 is then inserted into opening 406 of key 400. Key 400 is rotated if necessary to align protrusions 408 with engagement surfaces 306 and openings 308. Protrusions 408 are inserted through openings 308 and into association with engagement surfaces 306. The user can then apply torque to inner shell 302 in a clockwise or counterclockwise direction to either apply anti-theft device 300 to a bolt or remove it from a bolt.

It should be appreciated that many variations can be made to the description provided without departing from the scope of the invention as set forth herein.

1. An anti-tamper device, comprising:
an inner shell having a body and an end; and
an outer shell positioned to cover the end of the inner shell, wherein the inner shell and the outer shell are axially and rotatably secured together such that the inner shell and the outer shell rotate independent of each other.

2. The anti-tamper device of claim 1, wherein the outer shell forms an enclosure that contains at least a portion of the inner shell.

3. The anti-tamper device of claim 1, wherein the inner shell includes a ridge and an interior surface of the outer shell includes a channel communicating with the ridge.

4. The anti-tamper device of claim 1, wherein the outer shell includes a ridge and an exterior surface of the inner shell includes a channel communicating with the ridge.

5. The anti-tamper device of claim 1, wherein the outer shell and the inner shell rotate around a common axis.

6. The anti-tamper device of claim 1, wherein the outer shell includes at least one opening that exposes an outer surface of the inner shell.

7. The anti-tamper device of claim 6, wherein the at least one opening comprises a plurality of openings having a predetermined configuration.

8. The anti-tamper device of claim 7, wherein the inner shell includes a plurality of engagement surfaces.

9. The anti-tamper device of claim 8, wherein the plurality of engagement surfaces are positioned in the predetermined configuration.

10. The anti-tamper device of claim 9, wherein the outer shell is cylindrical, the openings are located on a wall positioned along a directrix of the outer shell, and the engagement surfaces are located on a surface of the inner shell such that that the openings are capable of registration with the engagement surfaces.

11. The anti-tamper device of claim 9, wherein the outer shell is cylindrical, the openings are located on a base of the outer shell, and the engagement surfaces are located on a surface of the inner shell such that the openings are capable of registration with the engagement surfaces.

12. The anti-tamper device of claim 9, wherein the engagement surfaces comprise a plurality of spaced apart grooves positioned in an outer surface of the inner shell

13. The anti-tamper device of claim 9, wherein the openings comprise a plurality of spaced apart slots positioned in the outer shell.

14. The anti-tamper device of claim 9, wherein the inner shell has at least two cylindrical portions having different radii.

15. The anti-tamper device of claim 14, wherein the plurality of engagement surfaces are located on the cylindrical portion having the greatest radius.

16. The anti-tamper device of claim 14, wherein the cylindrical portion having the greatest radius includes a channel.

17. The anti-tamper device of claim 14, wherein the cylindrical portion having the greatest radius includes a ridge.

18. The anti-tamper device of claim 14, wherein the outer shell has at least two cylindrical portions having different radii and having a complimentary relationship with the cylindrical portions of the inner shell.

19. The anti-tamper device of claim 18, wherein the plurality of openings are located on the cylindrical portion of the outer shell having the greatest radius.

20. The anti-tamper device of claim 18, wherein the cylindrical portion of the outer shell having the greatest radius includes a channel.

21. The anti-tamper device of claim 18, wherein the cylindrical portion of the outer shell having the greatest radius includes a ridge.

22. The anti-tamper device of claim 1, wherein the outer shell is polygonal.

23. The anti-tamper device of claim 1, wherein the inner shell is a lug nut.

24. A method of making the anti-tamper device of claim 1, comprising:
selecting the inner shell;
selecting the outer shell;
securing the inner shell to the outer shell such that the inner shell and the outer shell rotate independent of each other.

25. The method of claim 24, wherein the step of selecting the outer shell comprises:
selecting the outer shell to have a cylindrical shape.

26. The method of claim 24, wherein the step of selecting the outer shell comprises:
selecting the outer shell to have polygonal shape.

27. The method of claim 24, wherein the step of securing the inner shell to the outer shell comprises:
forming a ridge on the inner shell;
forming a channel on the outer shell; and
placing the ridge within the channel.

28. The method of claim 24, wherein the step of securing the inner shell to the outer shell comprises:
forming a channel on the inner shell;
forming a ridge on the outer shell; and
placing the ridge within the channel.

29. The method of claim 24, further comprising:
selecting a predetermined configuration;
forming at least one opening in the outer shell arranged in the predetermined configuration;
forming at least one engagement surface on the inner shell arranged in the predetermined configuration.

30. The method of claim 29, wherein the step of forming the at least one opening comprises:
forming a plurality of spaced apart slots on the outer shell.

31. The method of claim 29, wherein the step of forming the at least one engagement surface comprises:
forming a plurality of spaced apart grooves on an outer surface of the inner shell.

32. The method of claim 29, wherein the outer shell is cylindrical, the at least one opening is formed on a wall positioned along a directrix of the outer shell, and the at least one engagement surface is formed on a surface of the inner shell such that the at least one opening and the at least one engagement surface are capable of registration with each other.

33. The method of claim 29, wherein the outer shell is cylindrical and the at least one opening is formed on a base of the outer shell and the at least one engagement surface is formed on a surface of the inner shell such that the at least one opening and the at least one engagement surface are capable of registration with each other.

34. The method of claim 29, wherein the step of selecting the inner shell comprises:
selecting the inner shell to have at least two cylindrical portions having different radii.

35. The method of claim 34, wherein the step of forming the at least one engagement surface comprises:
forming the at least one engagement surface in the cylindrical portion having the greatest radius.

36. The method of claim 34, further comprising:
forming a ridge on the cylindrical portion having the greatest radius.

37. The method of claim 34, further comprising:
forming a channel on the cylindrical portion having the greatest radius.

38. The method of claim 34, wherein the step of selecting the outer shell comprises:
selecting the outer shell to have at least two cylindrical portions having different radii and having a complimentary relationship to the two cylindrical portions of the inner shell.

39. The method of claim 38, wherein the step of forming the at least one opening comprises:
forming the at least one opening on the cylindrical portion of the outer shell having the greatest radius.

40. The method of claim 38, further comprising:
forming a ridge on the cylindrical portion of the outer shell having the greatest radius.

41. The method of claim 38, further comprising:
forming a channel on the cylindrical portion of the outer shell having the greatest radius.

42. The method of claim 29, further comprising:
forming a key having at least one protrusion arranged in the predetermined configuration.

43. The method of claim 42, wherein the step of forming a key comprises:
selecting the key to include a socket; and
providing the socket with the at least one protrusion.

44. A method of using the anti-tamper device of claim 1, comprising:
placing the inner shell over a bolt.

45. The method of claim 44, wherein the step of placing comprises:
positioning one of the inner shell and the outer shell so that one or more openings located on the outer shell are in registration with the one or more engagement surfaces located on the inner shell;
engaging a key with the engagement surfaces; and
utilizing the key to rotate the inner shell over the bolt.

46. A method of using the anti-tamper device of claim 1, comprising:
removing the inner shell from a bolt.

47. The method of claim 46, wherein the step of removing comprises:
positioning one of the inner shell and the outer shell so that one or more openings located on the outer shell are in registration with the one or more engagement surfaces located on the inner shell;
engaging a key with the engagement surfaces; and
utilizing the key to rotate inner shell off the bolt.

48. An anti-tamper kit, comprising:
an anti-tamper device that comprises an inner shell having a body and an end, and an outer shell positioned to cover the end, wherein the inner shell and outer shell are axially and rotatably secured together such that the inner shell and the outer shell rotate independent of each other; and
a key.

49. The anti-tamper kit of claim 48, wherein the key comprises a socket.

50. The anti-tamper kit of 49, wherein the socket includes at least one protrusion.

51. The anti-tamper kit of claim 48, wherein the outer shell includes a plurality of spaced apart openings arranged in a predetermined configuration and the inner shell includes a plurality of spaced apart engagement surfaces arranged in the predetermined configuration, wherein the plurality of openings are capable of registration with the plurality of engagement surfaces.

52. The anti-tamper kit of claim 51, wherein the outer shell is cylindrical, the plurality of spaced apart openings are formed on a wall positioned along a directrix of the outer shell, and the plurality of engagement surfaces are formed on a surface of the inner shell such that the openings and the engagement surfaces are capable of registration with each other.

53. The method of claim 51, wherein the outer shell is cylindrical, the plurality of spaced apart openings are formed on a base of the outer shell, and the engagement surfaces are formed on a surface of the inner shell such that the plurality of spaced apart openings and the plurality of spaced apart engagement surfaces are capable of registration with each other.
